(19) United States
(12) Patent Application Publication
(10) Pub. No.: US 2026/0356303 A1
(43) Pub. Date: Nov. 12, 2026

(54) WORKING VEHICLE

(71) Applicant: Kubota Corporation, Osaka (JP)

(72) Inventors: Kenta TAKAYA, Sakai-shi (JP); Susumu TAKEOKA, Sakai-shi (JP); Akito FUKUYAMA, Sakai-shi (JP)

(21) Appl. No.: 19/717,734

(22) Filed: Jun. 24, 2026

Related U.S. Application Data
(63) Continuation of application No. PCT/JP2024/038072, filed on Oct. 25, 2024.

(30) Foreign Application Priority Data
Jan. 19, 2024 (JP) 2024-006466

(51) Int. Cl. B60R 11/04; B60R 11/00; B62D 25/06; B62D 33/06; B62D 49/06

(52) U.S. Cl. CPC B60R 11/04; B62D 25/06; B62D 33/0617; B60R 2011/004; B62D 49/06

(57) ABSTRACT

A tractor includes a plurality of detectors to detect a detection target in at least two directions around a tractor body. The plurality of detectors is located at a height of a roof of a cabin of the tractor body.

### CROSS REFERENCE TO RELATED APPLICATIONS

This application claims the benefit of priority to Japanese Patent Application No. 2024-006466 filed on Jan. 19, 2024 and is a Continuation Application of PCT Application No. PCT/JP 2024/038072 filed on Oct. 25, 2024. The entire contents of each application are hereby incorporated herein by reference.

### BACKGROUND OF THE INVENTION

### 1. Field of the Invention

The present invention relates to working vehicles.

### 2. Description of the Related Art

Conventionally, a technique of a working vehicle to detect a detection target around a tractor body is known. For example, JP 2023-078903 A discloses such a configuration.

JP 2023-078903 A describes a working vehicle including a ridge identification unit that detects and identifies an obstacle such as a ridge in front of a tractor body. The ridge identification unit includes a sensor such as a distance measuring sensor.

The distance measuring sensor as described above detects an obstacle by transmitting a radio wave such as a millimeter wave and receiving a radio wave reflected by an obstacle that is a detection target. Here, depending on the position where the distance measuring sensor is installed, it may be difficult to detect the detection target.

### SUMMARY OF THE INVENTION

Example embodiments of the present disclosure provide working vehicles capable of suitably detecting a detection target.

The problem to be solved by example embodiments of the present disclosure is as described above, and example embodiments for solving the problem will be described below.

A working vehicle according to an example embodiment of the present disclosure includes a cabin including a roof, and at least one detector located at a height of the roof and to detect a detection target around a tractor body.

According to an example embodiment of the present disclosure, it is possible to suitably detect a detection target.

The at least one detector according to an example embodiment of the present disclosure includes a front detector to detect a front of the tractor body.

According to an example embodiment of the present disclosure, it is possible to suitably detect a detection target in front of the tractor body.

The at least one detector according to an example embodiment of the present disclosure includes a rear detector to detect a rear of the tractor body.

According to an example embodiment of the present disclosure, it is possible to suitably detect a detection target behind the tractor body.

The at least one detector according to an example embodiment of the present disclosure includes a side detector to detect at least one of a left side or a right side of the tractor body.

According to an example embodiment of the present disclosure, it is possible to suitably detect a detection target on the left side or the right side of the tractor body.

A plurality of the detectors according to an example embodiment of the present disclosure is provided.

According to an example embodiment of the present disclosure, it is possible to suitably perform detection in a plurality of directions.

A working vehicle according to an example embodiment of the present disclosure includes a plurality of imagers located at a height of the roof to image surroundings of the tractor body.

According to an example embodiment of the present disclosure, it is possible to suitably perform imaging using an imager.

A working vehicle according to an example embodiment of the present disclosure includes a support located on an outer periphery of the roof to support the detector and the imager.

According to an example embodiment of the present disclosure, the plurality of detectors and the plurality of imagers can be located on the outer periphery of the roof using the support.

The roof according to an example embodiment of the present disclosure includes a top portion, and the detector is located such that an upper surface of the detector is below the top portion.

According to an example embodiment of the present disclosure, the working vehicle can be made compact in the vertical direction, and the working vehicle can be easily stored and transported in a garage or the like.

The at least one detector according to an example embodiment of the present disclosure is a radar to detect the detection target by emitting a radio wave, the support includes a front support disposed in front of the roof, and the front support supports the radar and the imager.

According to an example embodiment of the present disclosure, it is possible to suitably perform detection and imaging using radio waves in front of the tractor body.

A working vehicle according to an example embodiment of the present disclosure includes a position detector to detect a position of the tractor body and supported by the front support, in which the radar is located such that an upper surface of the radar is positioned below the position detector.

According to an example embodiment of the present disclosure, the working vehicle can be made compact in the vertical direction, and the working vehicle can be easily stored and transported in a garage or the like.

A support according to an example embodiment of the present disclosure includes a side support located on a side of the roof, and includes a connecting portion that connects the front support and the side support to each other.

According to an example embodiment of the present disclosure, structures capable of supporting the detector and the imager on the front side and the side of the tractor body can be suitably connected to each other.

An outer peripheral portion of the roof according to an example embodiment of the present disclosure includes a recess that is recessed toward a center side of the roof in a plan view, and the plurality of detectors and the plurality of imagers include the detector and the imager located adjacent to each other so as to be located inside the recess.

According to an example embodiment of the present disclosure, the detector and the imager located on the outer peripheral portion of the roof can be made inconspicuous.

The support according to an example embodiment of the present disclosure includes a cover portion that covers the detector and the imager from above, the cover portion includes a side wall that is not located within an angle of view of the imager, and the detector covered by the cover portion extends along the side wall.

According to an example embodiment of the present disclosure, it is possible to prevent the detector from being positioned within the angle of view of the imager while disposing the detector in the vicinity of the imager.

One of a plurality of the detectors and a plurality of the imagers according to an example embodiment of the present disclosure is located at least on each of four sides in a plan view of the roof so as to enable detection or imaging in forward, rearward, and both left and right directions from the tractor body, and another of the plurality of the detectors and the plurality of the imagers is located at least on each of four corners in a plan view of the roof so as to enable detection or imaging in forward, rearward, and both left and right directions from the tractor body.

According to an example embodiment of the present disclosure, a plurality of detectors and a plurality of imagers can be located at positions where the detectors and the imagers can be prevented from being located in the mutual imaging range and detection range.

According to an example embodiment of the present disclosure, one of the plurality of detectors and the plurality of imagers is located on both four sides and four corners of the roof in a plan view.

According to an example embodiment of the present disclosure, a blind spot of a detection range of a detector or an imaging range of an imager can be reduced.

According to an example embodiment of the present disclosure, it is possible to suitably detect a detection target.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is a side view illustrating an overall configuration of a tractor according to a first example embodiment of the present disclosure.

FIG. 2 is a perspective view illustrating a roof of a cabin.

FIG. 3 is a plan view illustrating the roof.

FIG. 4 is a side view illustrating the roof.

FIG. 5 is an exploded perspective view illustrating a position detector, a camera, a radar, a camera support, a radar support, a front support, a rear support, and a side support.

FIG. 6 is an exploded perspective view illustrating the position detector, a front camera, a front camera support, and a front support.

FIG. 7 is an exploded perspective view illustrating a rear camera and a rear camera support.

FIG. 8 is a perspective view illustrating a left side camera and a side camera support.

FIG. 9 is an exploded perspective view illustrating a front radar, a front radar support, and a front support.

FIG. 10 is an exploded perspective view illustrating a rear radar, a rear radar support, and a rear support.

FIG. 11 is a rear perspective view illustrating a rear portion of the roof.

FIG. 12 is an enlarged side view illustrating a side portion of a roof of a tractor according to a second example embodiment of the present disclosure.

FIG. 13A is a plan view illustrating a front camera, a front radar, a front radar support and a front support of a tractor according to a third example embodiment of the present disclosure. FIG. 13B is a side view illustrating a front camera, a front radar, a front radar support, and a front support.

FIG. 14 is a plan view illustrating a roof of a tractor according to a fourth example embodiment of the present disclosure.

FIG. 15 is a plan view illustrating a roof of a tractor according to a fifth example embodiment of the present disclosure.

### DETAILED DESCRIPTION OF THE EXAMPLE EMBODIMENTS

In the following description, directions indicated by arrows U, D, F, B, L, and R in the drawings are defined as an upward direction, a downward direction, a forward direction, a backward direction, a left direction, and a right direction, respectively.

First, an overall configuration of a tractor 1 according to an example embodiment of the present disclosure will be described.

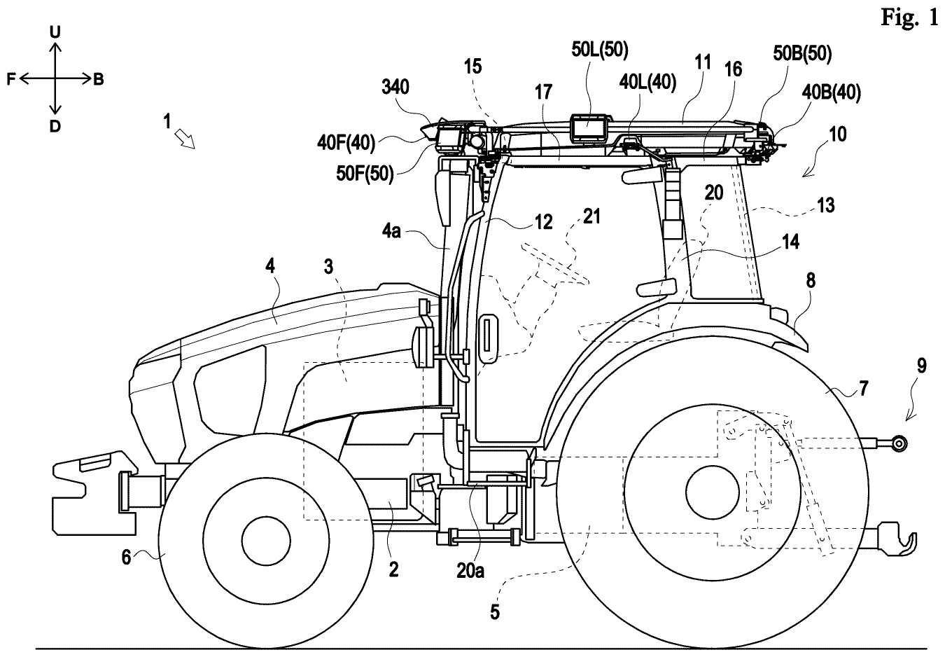

The tractor 1 illustrated in FIG. 1 mainly includes a machine body frame 2, an engine 3, a hood 4, a transmission case 5, front wheels 6, rear wheels 7, fenders 8, a lifting device 9, a cabin 10, a seat 20, a steering wheel 21, and the like.

The machine body frame 2 is a frame-shaped structure including a plurality of panels. The machine body frame 2 preferably has a substantially rectangular shape in plan view. The machine body frame 2 is disposed in a front portion of the tractor 1 with its longitudinal direction oriented in the front-rear direction. The engine 3 is fixed to a rear portion of the machine body frame 2. The engine 3 is covered with the hood 4. The transmission case 5 is fixed to a rear portion of the engine 3. A muffler 4a that discharges exhaust gas of the engine 3 is disposed on the right side of the hood 4.

The front portion of the machine body frame 2 is supported by the pair of left and right front wheels 6 through a front axle mechanism (not illustrated). A rear portion of the transmission case 5 is supported by the pair of left and right rear wheels 7 through a rear axle mechanism (not illustrated). The pair of left and right rear wheels 7 are substantially covered from above by the fenders 8.

The lifting device 9 is provided at the rear portion of the transmission case 5. Various working devices (for example, a cultivator or the like) can be attached to the lifting device 9. The lifting device 9 can lift and lower the attached working device by an actuator such as a hydraulic cylinder. Power of the engine 3 can be transmitted to the working device attached to the lifting device 9 via a PTO shaft (not illustrated).

Power of the engine 3 can be transmitted to the front wheel 6 through the front axle mechanism and can be transmitted to the rear wheel 7 through the rear axle mechanism after being shifted by a transmission (not illustrated) housed in the transmission case 5. The front wheels 6 and the rear wheels 7 are rotationally driven by the power of the engine 3, and the tractor 1 can travel. In addition, the working device attached to the lifting device 9 can be driven by the power of the engine 3.

The cabin 10 is provided behind the engine 3. The cabin 10 is placed on a tractor body (such as the transmission case 5). An interior space in which an operator rides is provided inside the cabin 10. As illustrated in FIG. 1, a seat 20 on which a driver sits is disposed substantially at the center of the cabin 10. The cabin 10 is provided with an auxiliary step 20a for getting in and out of the seat 20. Further, a steering wheel 21 to adjust the turning angle of the front wheels 6 is disposed in the front portion of the cabin 10.

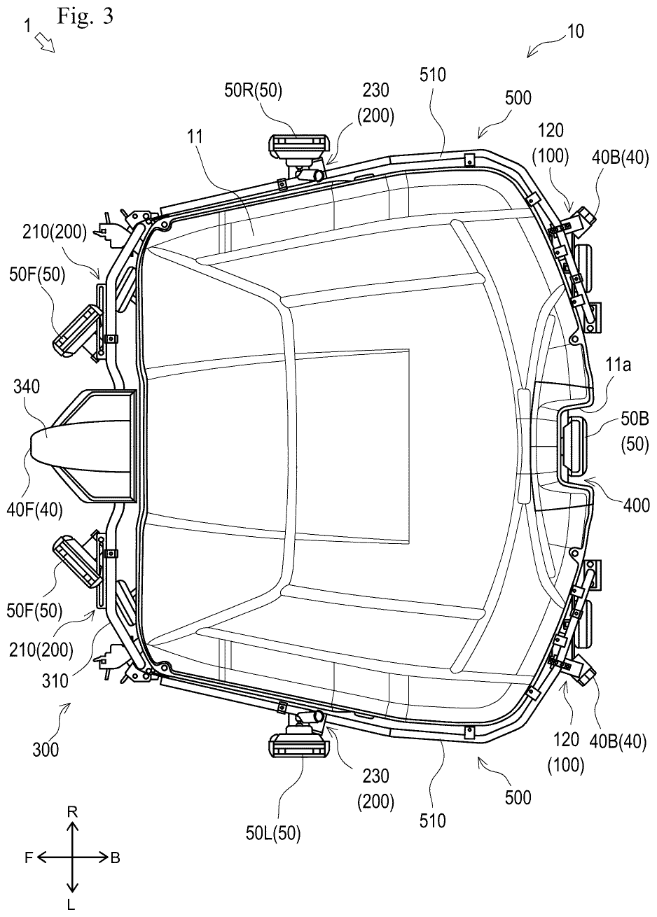

The cabin 10 is provided with a roof 11 defining a ceiling (roof) portion. The roof 11 preferably has a substantially rectangular shape in plan view (see FIG. 3). The cabin 10 includes a front pillar 12 that supports a front portion of the roof 11, a rear pillar 13 that supports a rear portion of the roof 11, and a center pillar 14 that supports a substantially central portion (intermediate portion) in the front-rear direction of the roof 11. The pillars are located on both left and right sides of the cabin 10. The cabin 10 includes a front beam 15 that couples upper ends of the left and right front pillars 12, a rear beam 16 that couples upper ends of the left and right rear pillars 13 and the left and right center pillars 14, and a side beam 17 that couples the upper ends of the front pillars 12 and the center pillars 14. The side beams 17 are positioned on both left and right sides of the cabin 10.

The roof 11, the pillars, and the beams preferably have a hollow shape. Wiring to be connected to equipment (for example, a position detector 30, a camera 40, a radar 50, and the like, which will be described later) provided in the tractor 1 can be inserted into the roof 11, each pillar, and a space inside each beam.

In addition, the tractor 1 according to the present example embodiment includes a position detector 30, a camera 40, a radar 50, a camera support 100, a radar support 200, a front support 300, a rear support 400, and a side support 500.

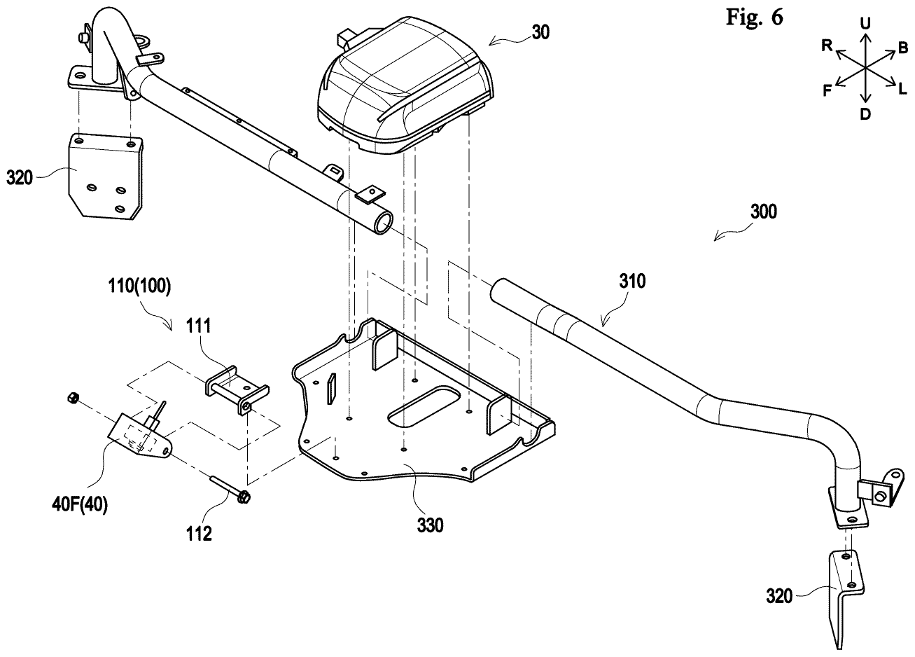

The position detector 30 illustrated in FIG. 6 is a device to detect a position (position information including latitude and longitude) of a tractor body using a satellite positioning system (GNSS) such as a GPS, various sensors, and the like. The position detector 30 includes appropriate reception means for receiving a satellite signal transmitted from a satellite. The position detector 30 is attached to an attachment target (front support 300 to be described later) disposed in front of the roof 11 of the cabin 10. Note that the arrangement of the position detector 30 will be described in detail later.

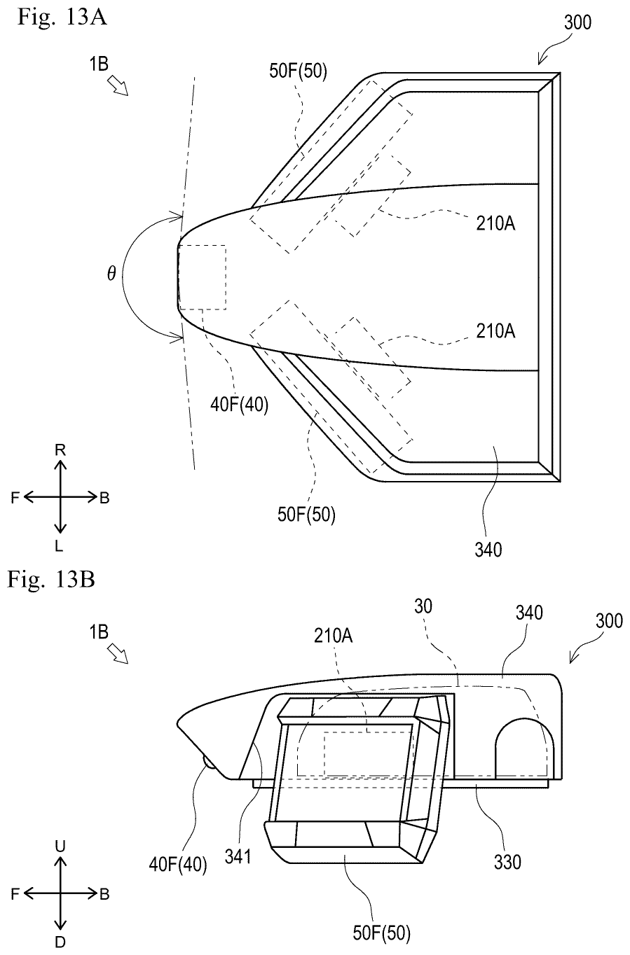

The camera 40 illustrated in FIGS. 1 to 3 can image the periphery of the tractor body. The tractor 1 can control the operation of the tractor body based on the image captured by the camera 40. For example, a person's appearance is learned on the basis of an image captured by a camera, and in a case where it is detected that a person approaches the vicinity of the tractor 1 from an imaging result of each camera, control for stopping the tractor 1 can be performed. Note that the use of each camera is not limited to this, and the captured image can be used for various uses. As the angle θ of the angle of view (viewing angle) of the camera 40, for example, 190° can be adopted (see FIG. 13A). Note that the angle θ is not limited to the above-described value, and various values can be adopted.

A plurality of cameras 40 is disposed around the roof 11 so as to be able to image the front, rear, left, and right of the tractor body. Hereinafter, the camera 40 disposed in front of the roof 11 so as to be able to image the front of the tractor body is referred to as a “front camera 40F”. Further, the cameras 40 disposed on the left and right sides of the roof 11 so as to be able to image both left and right sides of the tractor body are referred to as “left side camera 40L” and “right side camera 40R”, respectively. Further, the camera 40 disposed behind the roof 11 so as to be able to image the rear of the tractor body is referred to as a “rear camera 40B”. A pair of rear cameras 40B is located at intervals in the left-right direction. As described above, in the present example embodiment, five cameras 40 are disposed around the roof 11, for example. Note that the installation of each camera 40 will be described in detail later.

The radar 50 illustrated in FIGS. 1 to 3 can detect a detection target around the tractor body using radio waves (for example, millimeter waves). Examples of the detection target include a structure formed of metal or concrete, another vehicle, a person, and the like. The radar 50 is provided with a sensor (for example, a millimeter wave sensor) that emits radio waves and receives the radio waves reflected by the detection target to detect the detection target.

A plurality of radars 50 is disposed around the roof 11 so as to be able to detect detection targets on the front, rear, left, and right of the tractor body. Hereinafter, the radar 50 disposed in front of the roof 11 so as to be able to detect a detection target in front of the tractor body is referred to as a “front radar 50F”. A pair of front radars 50F is located at intervals in the left-right direction. Further, the radars 50 disposed on the left and right sides of the roof 11 so as to be able to detect detection targets on both left and right sides of the tractor body are referred to as “left side radar 50L” and “right side radar 50R”, respectively. Further, the radar 50 disposed behind the roof 11 so as to be able to detect a detection target behind the tractor body is referred to as a “rear radar 50B”. As described above, in the present example embodiment, five of the radars 50 are disposed around the roof 11, for example. Note that the installation of each radar 50 will be described in detail later.

The position detector 30, the camera 40, and the radar 50 are communicably connected to an appropriate controller configured or programmed to control traveling of the tractor 1 via wiring. The controller can be configured or programmed to detect the position information of the tractor body based on the GNSS signal received by the position detector 30. Further, the controller can be configured or programmed to execute control to drive the tractor 1 in an automated manner (automated driving control) on the basis of the position information, the image captured by the camera 40, and the detection result of the radar 50. The automated driving control includes, for example, control for steering the tractor body in an automated manner so as to travel straight in parallel to a set predetermined traveling reference line, control for the tractor body to travel in an automated manner along the created target traveling route, and control for the tractor body to stop or decelerate in an automated manner by detecting an obstacle around the tractor body.

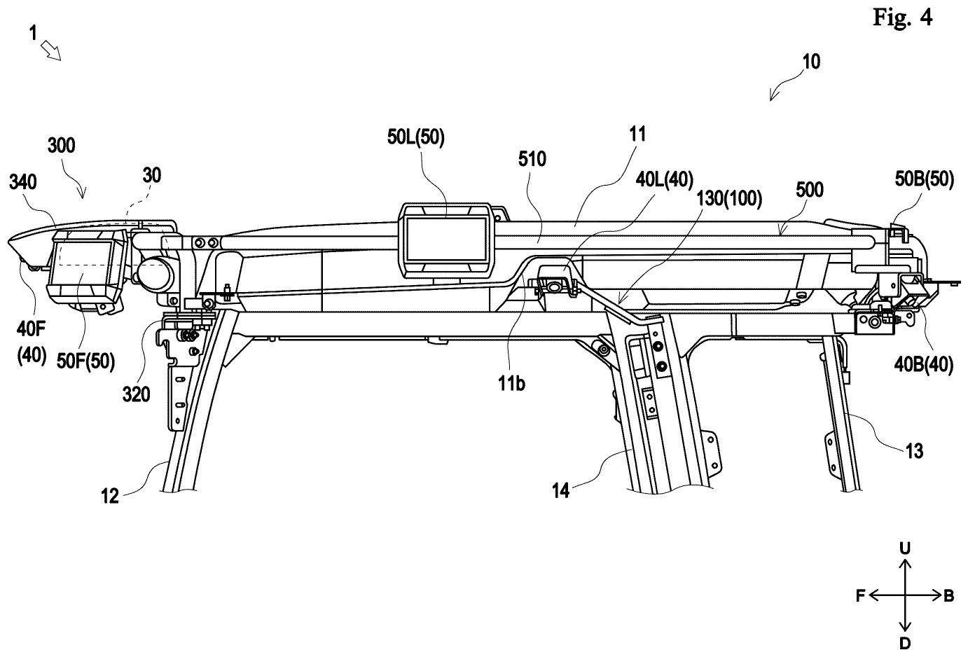

The camera support 100 illustrated in FIGS. 4 to 6 is attached to an attachment target around the roof 11 and supports the camera 40. Note that an attachment target and an attachment of the camera support 100 will be described later. The camera support 100 includes a front camera support 110, rear camera supports 120, and side camera supports 130.

The front camera support 110 illustrated in FIG. 6 supports the front camera 40F. In the present example embodiment, the front camera support 110 is attached to an upper surface of a plate-shaped attachment target (support plate 330 to be described later) disposed in front of the roof 11. Front camera support 110 includes a fixture 111 and a support shaft 112.

The fixture 111 is a portion that can be fixed to an attachment target. The fixture 111 is fixed using a fastener such as a bolt. The fixture 111 include a pair of left and right side walls extending upward. The support shaft 112 whose axial direction is oriented to the left and right is provided on left and right side walls of the fixture 111. The support shaft 112 can be, for example, a bolt.

As illustrated in FIG. 6, the front camera 40F is disposed between the pair of side walls of the fixture 111, and is supported by the support shaft 112. The front camera 40F is supported so as to be vertically rotatable about the support shaft 112, for example, by loosening the bolt of the support shaft 112. The angle of the front camera 40F in the vertical direction can be adjusted by tightening the bolt in a state where the front camera 40F is oriented at an arbitrary angle.

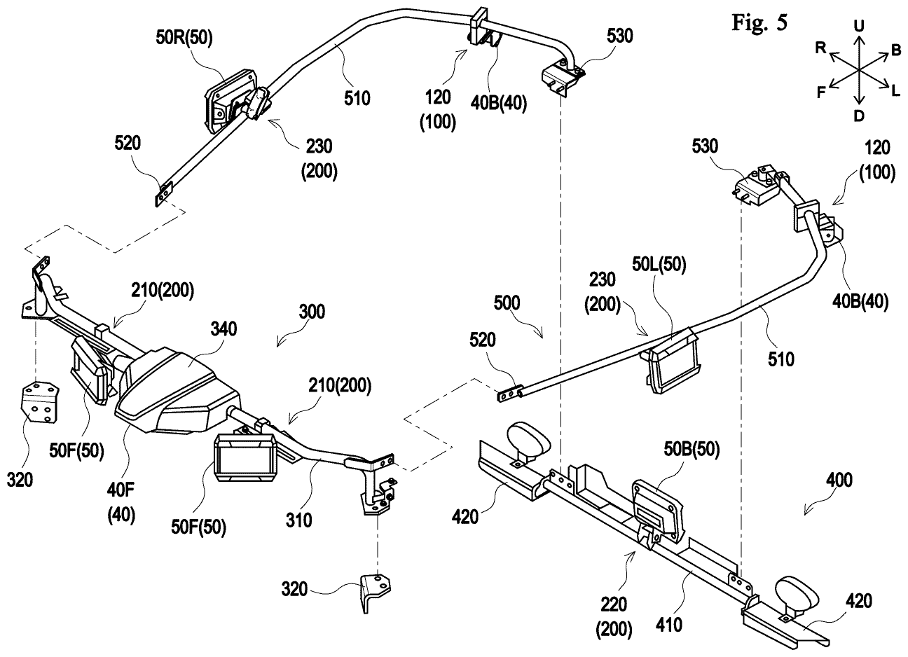

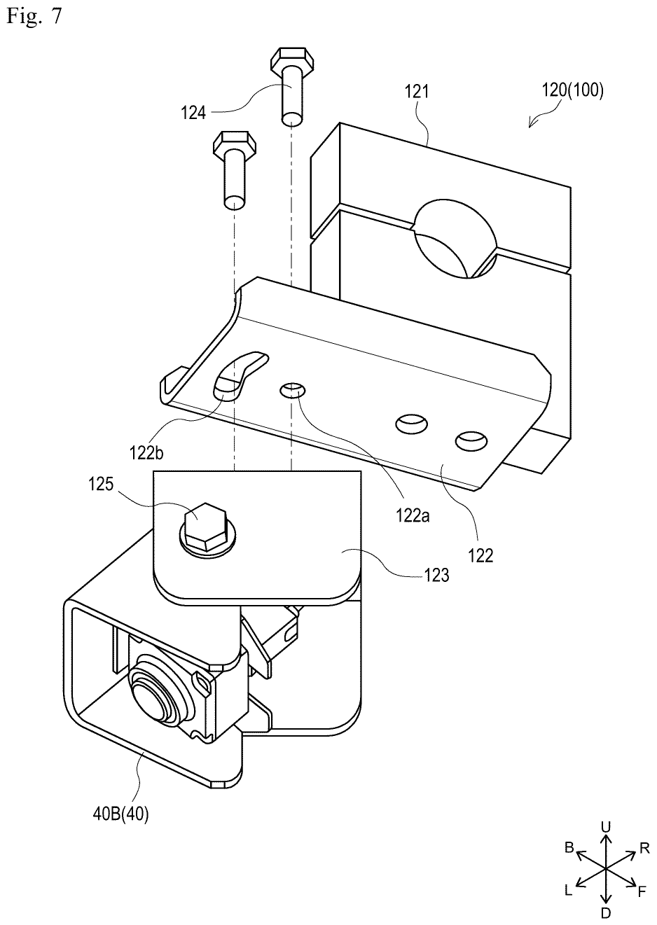

The rear camera supports 120 illustrated in FIGS. 5 and 7 support the rear cameras 40B. In the present example embodiment, the rear camera supports 120 are each attached to a round bar-shaped attachment target (rear portion of a side support bracket 510 to be described later) disposed behind the roof 11, and support the rear camera 40B so as to hang down. A pair of rear camera supports 120 is provided at an interval in the left-right direction so as to support the left and right rear cameras 40B, respectively (see FIG. 5). The pair of rear camera supports 120 is substantially bilaterally symmetrical. Hereinafter, the configuration of the rear camera supports 120 will be described focusing on the left rear camera support 120. The rear camera support 120 includes a clamp 121, a fixture 122, a horizontal rotator 123, a first support shaft 124, and a second support shaft 125.

The clamp 121 illustrated in FIG. 7 is a portion to be attached to an attachment target. The clamp 121 is attached to a round bar-shaped attachment target by sandwiching the attachment target between structures divided into upper and lower portions.

The fixture 122 is a portion fixed to the lower surface of the clamp 121. The fixture 122 preferably has a substantially plate shape with a plate surface facing up and down. A shaft hole 122a vertically penetrates the fixture 122. Further, the fixture 122 is provided with a guide hole 122b that vertically penetrates the fixture 122 and preferably has an arc shape with the shaft hole 122a as a circular center.

The horizontal rotator 123 is a portion that supports the rear camera 40B and is provided to be horizontally rotatable with respect to the fixture 122. The horizontal rotator 123 includes a pair of left and right side walls extending downward. The horizontal rotator 123 is inserted into the shaft hole 122a of the fixture 122, and is connected to the fixture 122 via the first support shaft 124 whose axial direction is vertical. The first support shaft 124 can be, for example, a bolt. Further, the horizontal rotator 123 is provided with a bolt to be inserted into the guide hole 122b. Further, a second support shaft 125 whose axial direction is oriented to the left and right is provided on a pair of side walls of the horizontal rotator 123. The second support shaft 125 can be, for example, a bolt. The rear camera 40B (left rear camera 40B) is disposed between the pair of side walls of the horizontal rotator 123 and is supported by the second support shaft 125.

The horizontal rotator 123 is rotatably supported about the first support shaft 124 along the guide hole 122b by loosening the bolt of the first support shaft 124. The angle of the rear camera 40B in the horizontal direction can be adjusted by tightening the bolt in a state where the horizontal rotator 123 is oriented at an arbitrary angle. Further, the rear camera 40B is supported so as to be vertically rotatable about the second support shaft 125 by loosening the bolt of the second support shaft 125. The angle of the rear camera 40B in the vertical direction can be adjusted by tightening a bolt in a state where the rear camera 40B is directed at an arbitrary angle. In this manner, the rear camera 40B is supported so as to be able to adjust the angle in the horizontal direction and the vertical direction around the two axes.

The left rear camera support 120 has been described above. The right rear camera support 120 is also substantially similar to the left rear camera support 120 described above, and supports the right rear camera 40B such that the angles in the horizontal direction and the vertical direction can be adjusted.

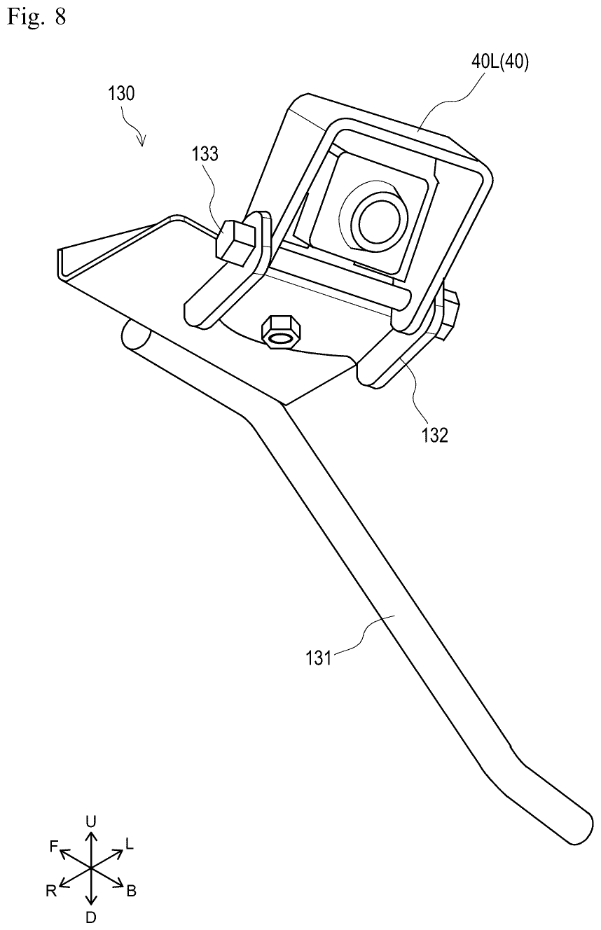

The side camera support 130 illustrated in FIGS. 4 and 8 supports the left side camera 40L and the right side camera 40R, respectively. A pair of side camera supports 130 is located on both left and right sides of the roof 11. The pair of side camera supports 130 is substantially bilaterally symmetrical. The side camera support 130 is attached to an attachment target (an upper end of a center pillar 14 to be described later) disposed on the side of the roof 11. Hereinafter, the configuration of the side camera support 130 will be described focusing on the left side camera support 130 that supports the left side camera 40L. The side camera support 130 includes a support bracket 131, a fixture 132, and a support shaft 133.

The support bracket 131 is a portion fixed to the center pillar 14. The support bracket 131 extends obliquely forward and upward from the center pillar 14 side. A front end of the support bracket 131 preferably has a substantially plate shape with a plate surface facing up and down.

The fixture 132 is a portion fixed to the support bracket 131. The fixture 132 is fixed to the lower surface of the front end of the support bracket 131 using a fastener such as a bolt. The fixture 132 includes a pair of front and rear side walls extending downward. Support shafts 133 whose axial directions are directed forward and backward are provided on the front and rear side walls of the fixture 132. The support shaft 133 can be, for example, a bolt.

As illustrated in FIG. 8, the left side camera 40L is disposed between the pair of side walls of fixture 132, and is supported by the support shaft 133. The left side camera 40L is supported so as to be vertically rotatable about the support shaft 133, for example, by loosening the bolt of the support shaft 133. The angle of the left side camera 40L in the vertical direction can be adjusted by tightening the bolt in a state where the left side camera 40L is oriented at an arbitrary angle.

The left side camera support 130 has been described above. The right side camera support 130 is also substantially similar to the left side camera support 130 described above, and supports the right side camera 40R such that the angle in the vertical direction can be adjusted.

The radar support 200 illustrated in FIGS. 5, 9, and 10 is attached to an attachment target around the roof 11 and supports the radar 50. Note that an attachment target and an attachment of the radar support 200 will be described later. The radar support 200 includes a front radar support 210, a rear radar support 220, and a side radar support 230.

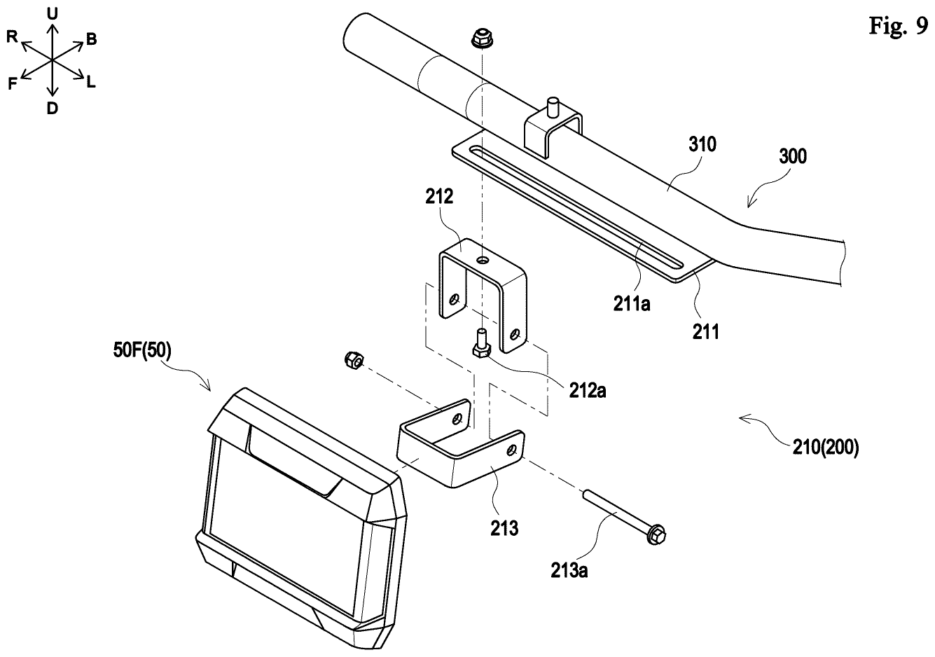

The front radar support 210 illustrated in FIGS. 5 and 9 supports the front radar 50F. In the present example embodiment, the front radar support 210 is attached to a round bar-shaped attachment target (front support bracket 310 to be described later) disposed in front of the roof 11, and supports the front radar 50F so as to hang down. A pair of front radar supports 210 is provided at an interval in the left-right direction so as to support the left and right front radars 50F, respectively (see FIG. 5). The pair of left and right front radars 50F is located on both sides in the left-right direction of the front camera support 110 (front camera 40F). Further, the pair of front radar supports 210 is substantially bilaterally symmetrical. Hereinafter, the configuration of the front radar support 210 will be described focusing on the left front radar support 210. The front radar support 210 includes a fixture 211, a horizontal rotator 212, and a vertical rotator 213.

The fixture 211 illustrated in FIG. 9 is a portion that can be fixed to an attachment target. The fixture 211 is fixed to an attachment target, for example, by welding or the like. The fixture 211 preferably has a substantially plate shape with a plate surface facing up and down. Further, the fixture 211 preferably has a shape elongated in the left-right direction. A hole 211a vertically penetrates the fixture 211. In the present example embodiment, the hole 211a preferably has an elongated hole shape extending in the left-right direction.

The horizontal rotator 212 is connected to the fixture 211 so as to be movable to the left and right and to be horizontally rotatable. The horizontal rotator 212 is provided on the lower surface of the fixture 211. The horizontal rotator 212 includes a pair of left and right side walls extending downward. The horizontal rotator 212 is inserted into the hole 211a of the fixture 211 and is connected to the fixture 211 via a first support shaft 212a whose axial direction is vertical. The first support shaft 212a can be, for example, a bolt.

The vertical rotator 213 is fixed to the front radar 50F and is vertically rotatably connected to the horizontal rotator 212. The vertical rotator 213 is appropriately fixed to the back surface (the surface opposite to the surface that emits radio waves) of the front radar 50F. The vertical rotator 213 includes a pair of left and right side walls extending rearward. The pair of side walls of the vertical rotator 213 is connected to the pair of side walls of the horizontal rotator 212 via the second support shaft 213a. The second support shaft 213a can be, for example, a bolt.

The horizontal rotator 212 is supported to be movable to the left and right along the long hole-shaped hole 211a and to be rotatable about the first support shaft 212a by loosening the bolt of the first support shaft 212a. The horizontal position and the angle in the horizontal direction of the front radar 50F (left front radar 50F) can be adjusted by tightening the bolt in a state where the horizontal rotator 212 is directed to an arbitrary angle at an arbitrary left-right position.

Further, the vertical rotator 213 is supported so as to be vertically rotatable about the second support shaft 213a by loosening the bolt of the second support shaft 213a. By tightening the bolts with the front radar 50F oriented at an arbitrary angle, the angle of the front radar 50F in the vertical direction can be adjusted. As described above, the front radar 50F is supported so as to be able to adjust the angles in the horizontal direction and the vertical direction about the two axes.

The left front radar support 210 has been described above. The right front radar support 210 is also substantially similar to the left front radar support 210 described above, and supports the right front radar 50F such that the angles in the horizontal direction and the vertical direction can be adjusted. Note that, in the example described above, the hole 211a of the fixture 211 preferably has an elongated hole shape. However, the hole 211a may have a round hole shape.

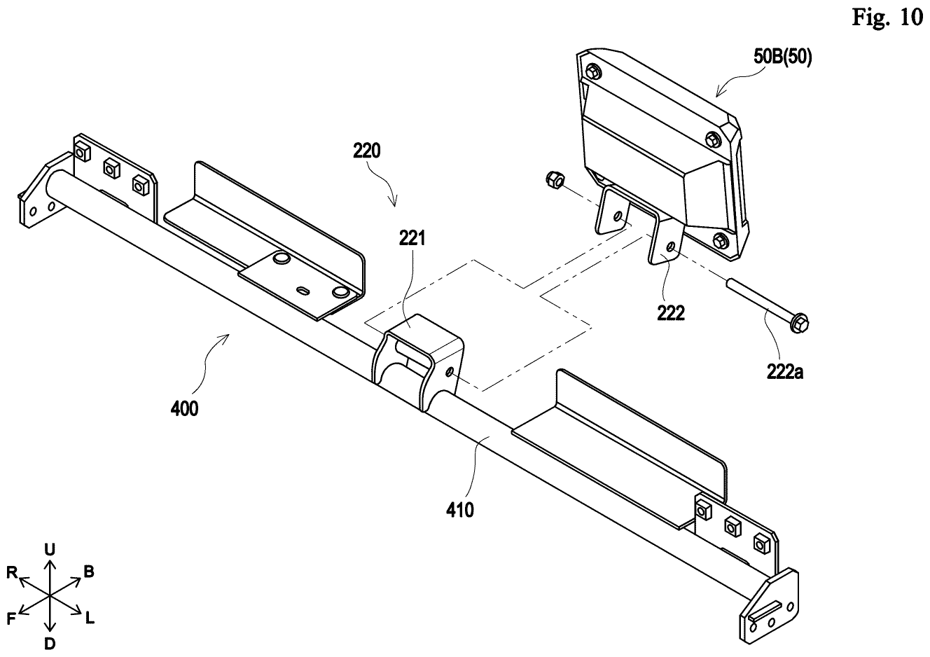

The rear radar support 220 illustrated in FIGS. 5 and 10 supports the rear radar 50B. In the present example embodiment, the rear radar support 220 is attached to a round bar-shaped attachment target (rear support bracket 410 to be described later) disposed on the rear side of the roof 11. The rear radar support 220 includes a fixture 221 and a vertical rotator 222.

The fixture 221 is a portion that can be fixed to an attachment target. The fixture 221 is fixed to an attachment target, for example, by welding or the like.

The vertical rotator 222 is fixed to the rear radar 50B and is vertically rotatably connected to the fixture 221. The vertical rotator 222 is appropriately fixed to the back surface of the rear radar 50B. The vertical rotator 222 includes a pair of left and right side walls extending downward.

As illustrated in FIG. 10, the pair of side walls of the vertical rotator 222 is connected to the fixture 221 via a support shaft 222a in a state where the fixture 221 is between the pair of side walls. The vertical rotator 222 is supported so as to be vertically rotatable about the support shaft 222a by loosening the bolt of the support shaft 222a. The angle of the rear radar 50B in the vertical direction can be adjusted by tightening the bolt in a state where the rear radar 50B is oriented at an arbitrary angle.

The side radar support 230 illustrated in FIG. 5 supports each of the left side radar 50L and the right side radar 50R. A pair of side radar supports 230 is provided so as to be located on both left and right sides of the roof 11. The pair of side radar supports 230 is substantially bilaterally symmetrical. In the present example embodiment, the pair of side radar supports 230 is attached to round bar-shaped attachment targets (side support brackets 510 to be described later) disposed on both left and right sides of the roof 11. Hereinafter, the configuration of the side radar support 230 will be described focusing on the right side radar support 230 that supports the right side radar 50R.

The side radar support 230 connects the right side radar 50R and the attachment target so as to adjust the angles in the horizontal and vertical directions of the right side radar 50R. The side radar support 230 according to the present example embodiment connects the right side radar 50R and the attachment target by a ball joint such that the angle of the right side radar 50R can be adjusted. Note that the left side radar support 230 is substantially similar to the right side radar support 230 described above, and supports the left side radar 50L such that the angles in the horizontal direction and the vertical direction can be adjusted.

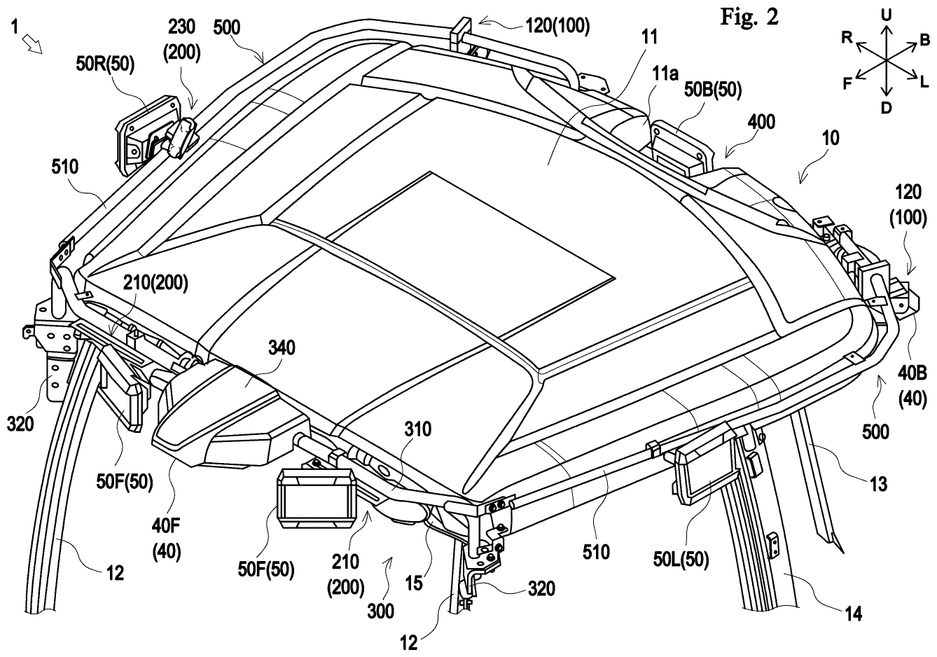

As described above, the respective devices (position detector 30, camera 40 (camera support 100), and radar 50 (radar support 200)) of the tractor 1 are positioned at the periphery (outer periphery) of the roof 11 via the front support 300, the rear support 400, and the side support 500. As illustrated in FIG. 3, in the present example embodiment, the front support 300, the rear support 400, and the side support 500 are disposed so as to surround substantially the entire periphery of the roof 11 in plan view (see FIGS. 2 and 3). Hereinafter, configurations of the front support 300, the rear support 400, and the side support 500, and attachments of the respective devices will be described.

The front support 300 illustrated in FIGS. 2 to 6 is capable of supporting devices and the like of the tractor 1 in front of the roof 11. The front support 300 according to the present example embodiment supports the position detector 30, the front camera 40F (front camera support 110), and the front radar 50F (front radar support 210). Note that, in FIG. 6, illustration of the front radar 50F and the front radar support 210 is omitted. As illustrated in FIG. 2, the front support 300 extends over the left and right front pillars 12. The front support 300 includes a front support bracket 310, a fixture 320, a support plate 330, and a cover 340.

The front support bracket 310 illustrated in FIGS. 5 and 6 is a main structural body of the front support 300. The front support bracket 310 includes a structure (for example, a hollow round bar) elongated in the left-right direction. The front support bracket 310 preferably has a shape that is appropriately bent according to a shape of a front portion of the roof 11 or a shape of a structure around the front portion of the roof 11. Both ends of the front support bracket 310 in the left-right direction extend downward. Further, the front support bracket 310 is divided into right and left portions, and include two structures that are bilaterally symmetrical to each other.

The fixture 320 illustrated in FIGS. 2 and 6 is fixed to the front pillar 12, and both ends of the front support bracket 310 in the left-right direction are attached. The fixture 320 is fixed to the upper ends of the left and right front pillars 12 using fasteners such as bolts. Further, the left and right fixtures 320 are fixed to both ends of the front support bracket 310 in the left-right direction using fasteners such as bolts.

The support plate 330 illustrated in FIG. 6 supports the position detector 30 and the front camera support 110. The support plate 330 preferably has a substantially plate shape with a plate surface facing up and down. A front portion of the support plate 330 in a plan view preferably has a tapered shape (shape in which a lateral width gradually decreases toward the front). The position detector 30 is attached to a central portion in the left-right direction on the upper surface of the support plate 330.

On the upper surface of the support plate 330, on both left and right side portions of the position detector 30, center side portions of the front support bracket 310 in the left-right direction (respective ends divided into left and right portions) are fixed by welding or the like. Further, on the upper surface of the support plate 330, the fixture 111 of the front camera support 110 is fixed in front of the position detector 30. As described above, in the present example embodiment, the support plate 330 is adopted as an attachment target of the front camera support 110.

The cover 340 illustrated in FIGS. 3 and 5 covers the support plate 330 from above. The cover 340 preferably has a substantially box shape that opens downward. The cover 340 preferably has a shape corresponding to the support plate 330 in plan view. The cover 340 is fixed to the upper surface of the support plate 330 using a fastener such as a bolt. The cover 340 configured as described above covers the position detector 30 provided on the upper surface of the support plate 330, the front camera 40F, and the front camera support 110. Note that an opening is located at the front end of cover 340 to expose the front camera 40F.

As illustrated in FIGS. 5 and 9, in the present example embodiment, the front support bracket 310 is adopted as an attachment target of the front radar support 210. As illustrated in FIGS. 3 and 5, in the present example embodiment, the left and right front radar supports 210 are provided so that the left and right front radars 50F are located on the left and right sides of the cover 340, respectively.

In the present example embodiment, the left and right front radars 50F and the front camera 40F are separated from each other in the left and right direction, and the left and right front radars 50F are disposed behind the front camera 40F so that the left and right front radars 50F are not positioned within the angle of view of the front camera 40F. In the present example embodiment, the left and right front radars 50F are inclined outward in the left-right direction with respect to the front in plan view by a predetermined angle (approximately 45 degrees in the illustrated example) such that other structures such as the cover 340 are not positioned in the detection ranges of the left and right front radars 50F. Since the front camera 40F and the front radar 50F are disposed as described above, it is possible to prevent other structures from being positioned in the imaging range of the front camera 40F and the detection range of the front radar 50F.

The rear support 400 illustrated in FIGS. 5, 10, and 11 is capable of supporting devices and the like of the tractor 1 behind the roof 11. The rear support 400 according to the present example embodiment supports the rear radar 50B (rear radar support 220). The rear support 400 is fixed to the rear of the rear beam 16. The rear support 400 includes a rear support bracket 410 and a bracket fixture 420.

The rear support bracket 410 is a main structural body of the rear support 400. The rear support bracket 410 includes a structure (for example, a hollow round bar) elongated in the left-right direction.

The bracket fixture 420 is a portion fixed to the rear portion of the rear beam 16. The bracket fixture 420 is provided at each of both ends of the rear support bracket 410 in the left-right direction.

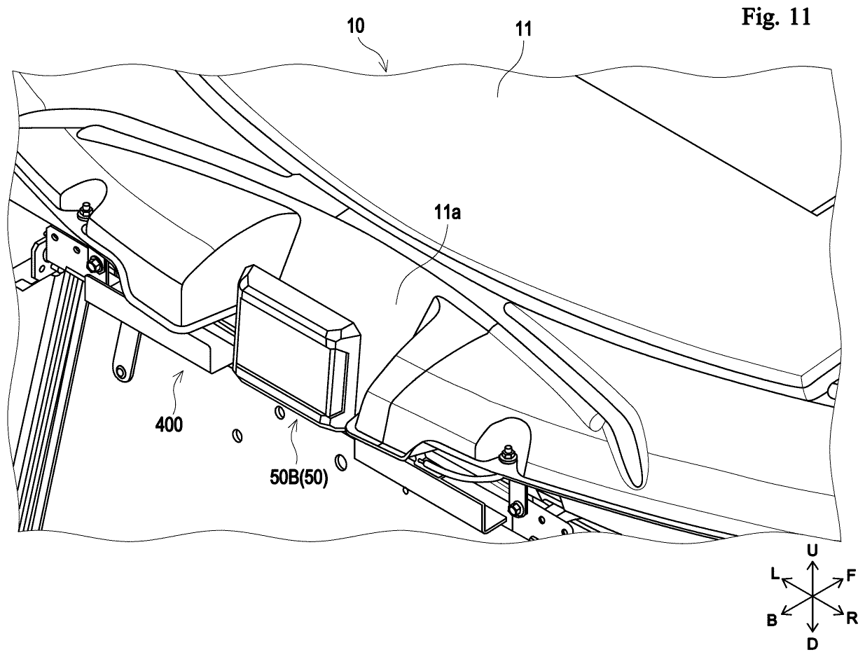

In the present example embodiment, the rear support bracket 410 is adopted as an attachment target of the rear radar support 220. As illustrated in FIG. 11, the rear radar 50B supported by the rear radar support 220 is located in a recess 11a that is recessed forward at the center in the left-right direction of the rear portion of the roof 11.

The side supports 500 illustrated in FIGS. 2 to 5 can support devices of the tractor 1 on both left and right sides of the roof 11. The side support 500 according to the present example embodiment supports the left side radar 50L, the right side radar 50R (side radar support 230), and the rear camera 40B (rear camera support 120).

The side support 500 is disposed across the front support 300 and the rear support 400. A pair of side supports 500 is provided so as to be positioned on both left and right sides of the roof 11. The pair of side supports 500 is substantially bilaterally symmetrical. Hereinafter, the configuration of the side support 500 will be described focusing on the left side support 500. The side support 500 includes a side support bracket 510, a front fixture 520, and a rear fixture 530.

The side support bracket 510 illustrated in FIG. 5 is a main structural body of the side support 500. The side support bracket 510 includes an elongated structure (for example, a hollow round bar) along a side portion of the roof 11. The side support bracket 510 preferably has an appropriately bent shape according to the shape of the side portion of the roof 11 and the like.

The front fixture 520 is a portion fixed to the front support bracket 310 of the front support 300. The front fixture 520 is provided at the front end of the side support bracket 510. The front fixture 520 is fixed to the left end (outer ends in the left-right direction) of the front support bracket 310 using a fastener such as a bolt. In a state where the front fixture 520 is fixed to the front support bracket 310, the front support bracket 310 and the side support bracket 510 are connected to each other.

The rear fixture 530 is a portion fixed to the rear support bracket 410 of the rear support 400. The rear fixture 530 is provided at the rear end of the rear support bracket 410. The rear fixture 530 is fixed to the left end (outer ends in the left-right direction) of the rear support bracket 410 using a fastener such as a bolt. In a state where the rear fixture 530 is fixed to the rear support bracket 410, the rear support bracket 410 and the side support bracket 510 are connected to each other.

The left side support 500 has been described above. The right side support 500 is also substantially similar to the left side support 500 described above.

In the present example embodiment, the side support bracket 510 is adopted as an attachment target of the side radar support 230 and the rear camera support 120. As illustrated in FIGS. 2 and 3, in the present example embodiment, the left and right side radar supports 230 are attached to the side support bracket 510 such that the left side radar 50L and the right side radar 50R are located substantially at the center in the front-rear direction on the side of the roof 11.

Further, as illustrated in FIGS. 3 and 5, in the present example embodiment, the left and right rear camera supports 120 are attached to the side support brackets 510 such that the left and right rear cameras 40B are located on both left and right sides of the rear radar 50B at the rear of the roof 11. More specifically, the rear camera support 120 is attached to a portion of the side support bracket 510 in the vicinity of the rear fixture 530.

In the present example embodiment, the rear radar 50B and the left and right rear cameras 40B are separated from each other in the left and right direction so that the rear radar 50B and the left and right rear cameras 40B are not positioned in the imaging range and the detection range of each other.

In the present example embodiment, the upper end of the center pillar 14 is adopted as an attachment target to which the side camera support 130 is attached. As illustrated in FIG. 4, in the present example embodiment, the side camera support 130 is attached to the upper end of the center pillar 14 such that the left side camera 40L (right side camera 40R) is located at substantially the center in the front-rear direction on the side portion of the roof 11. The left side camera 40L (right side camera 40R) supported by the side camera support 130 is located in a recess 11b that is recessed toward the center in the left-right direction at the center in the front-rear direction of the side portion of the roof 11.

As illustrated in FIG. 4, in the present example embodiment, both the left side camera 40L (right side camera 40R) and the left side radar 50L (right side radar 50R) are disposed substantially at the center in the front-rear direction on the side of the roof 11. The left side camera 40L (right side camera 40R) and the left side radar 50L (right side radar 50R) are adjacent to each other in the front-rear direction.

In the present example embodiment, the left side radar 50L (right side radar 50R) is disposed closer to the center in the left-right direction than the left side camera 40L (right side camera 40R) so that the left side radar 50L (right side radar 50R) is not positioned within the angle of view of the left side camera 40L (right side camera 40R).

The attachment arrangements of the respective devices (position detector 30, camera 40 (camera support 100), and radar 50 (radar support 200)) of the tractor 1 have been described above. With the above configuration, each camera 40 can be disposed so as to be able to image substantially the entire circumference (front, rear, left, and right) of the tractor body, and each radar 50 can be disposed so as to be able to detect substantially the entire circumference of the tractor body.

Further, in the present example embodiment, the cameras 40 and the radars 50 are located at the height position of the roof 11 by the camera support 100 and the radar support 200. More specifically, the cameras 40 and the radars 50 are disposed such that the height position of at least a portion of the cameras and the radars coincides with the height position of the roof 11 (when viewed in the horizontal direction, at least a part of each camera 40 and each radar 50 overlaps the roof 11) (see FIGS. 2 and 4). As a result, unlike a case where each camera 40 and each radar 50 are located at a relatively low position (for example, the height of the hood 4), it is possible to suppress detection (imaging) of an unintended target such as plants. Further, according to the present example embodiment, for example, unlike a case where the front radar 50F is installed in front of the hood 4, it is possible to reduce a blind spot in a detection range at the time of turning.

Further, in the present example embodiment, at least one of the radars 50 is disposed below the roof 11 in a range coinciding with the height position of the roof 11. Specifically, in the present example embodiment, the upper surfaces of the front radar 50F and the rear radar 50B are disposed below the top portion (highest portion) of the roof 11 (see FIG. 4). By disposing the front radar 50F and the rear radar 50B as described above, the height of the radar 50 in front of and behind the roof 11 can be reduced. As a result, for example, in a case where the tractor 1 is loaded into or unloaded from the container of the cargo bed of the transportation equipment, in a case where the tractor 1 is stored in the container in an inclined manner such that the front side or the rear side of the roof 11 becomes higher, it is possible to prevent the radars 50 in front of and behind the roof 11 from coming into contact with the ceiling of the container.

Note that at least one of the left side radar 50L and the right side radar 50R may also be disposed such that an upper surface thereof is positioned below the top portion of the roof 11. In a case where the upper surfaces of all the radars 50 are positioned below the top portion of the roof 11, the tractor 1 can be made compact in the vertical direction. This facilitates storage and transportation of the tractor 1 in a garage or the like.

Further, in the present example embodiment, at least one of the radars 50 is disposed below the detector 30 and the cover 340. Specifically, in the present example embodiment, upper surfaces of the front radar 50F and the rear radar 50B are disposed below an upper surface of the detector 30 and an upper surface of the cover 340 (see FIG. 4). Note that the upper surfaces of the detector 30 and the cover 340 are positioned below the top portion of the roof 11. In addition, at least one of the left side radar 50L and the right side radar 50R may also be disposed such that an upper surface thereof is positioned below the upper surface of the detector 30 and the upper surface of the cover 340. In addition, at least one of the radars 50 may be disposed such that the upper surface is positioned below a lower surface of the position detector 30 or a lower surface of the cover 340.

Further, the height position of each radar 50 is not limited to the above example. For example, at least one of the radars 50 can be disposed above the roof 11, the position detector 30, and the cover 340 in a range coinciding with the height position of the roof 11. For example, the present example embodiment illustrates an example in which an upper surface of at least one of the radars 50 (in the present example embodiment, the left side radar 50L and the right side radar 50R) is positioned above the top portion of roof 11, the upper surface of position detector 30, and the upper surface of cover 340. Furthermore, a lower surface of at least one of the radars 50 may be positioned above the upper surface of the position detector 30 and the upper surface of the cover 340.

In addition, an upper surface or lower surface of at least one of the radars 50 may be located at substantially the same height as the top portion of the roof 11, the upper surface of the position detector 30, and the upper surface of the cover 340, and the upper surface or lower surface of at least one of the radars 50 may be located at substantially the same height as the lowest portion of the roof 11, the lower surface of the position detector 30, and the lower surface of the cover 340. In addition, as the height position of each radar 50, various height positions can be adopted within a range that coincides with the height position of the roof 11.

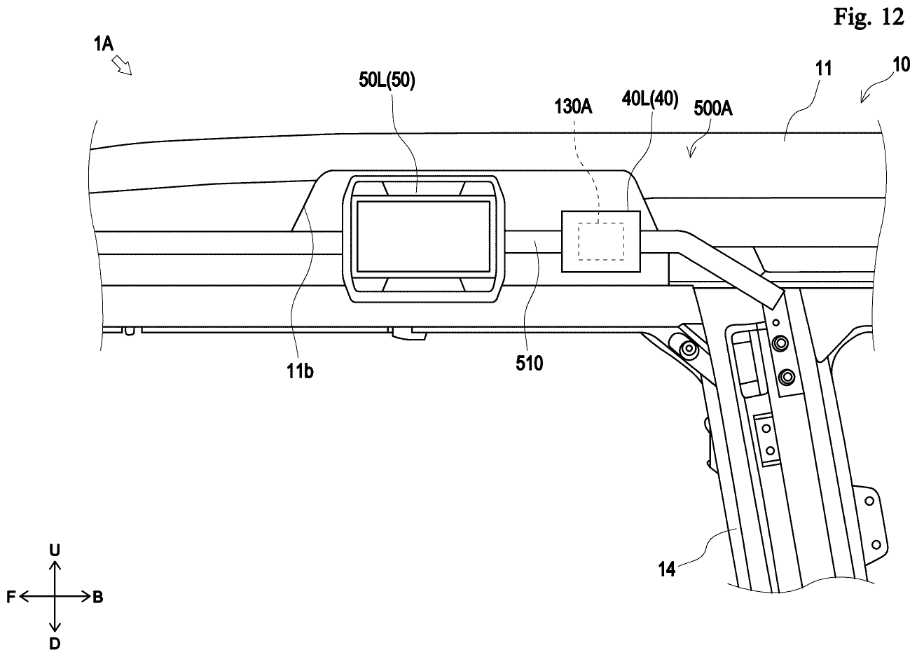

The tractor 1 according to the first example embodiment of the present disclosure has been described above. Here, attachment of the camera 40 (camera support 100) and the radar 50 (radar support 200) is not limited to the above-described examples, and various attachments can be adopted. Another example embodiment (second to fifth example embodiments) will be described below with reference to FIGS. 12 to 15. Hereinafter, configurations different from those of the first example embodiment will be described, and description of configurations similar to those of the first example embodiment will be omitted as appropriate.

First, a tractor 1A according to a second example embodiment will be described with reference to FIG. 12. The tractor 1A differs from the tractor according to the first example embodiment in a configuration of a side support 500A. In the side support 500A, the rear end of the side support bracket 510 is fixed not to the rear support bracket 410 but to the upper end of the center pillar 14. That is, in the second example embodiment, the rear support bracket 410 does not extend to the rear side (the rear support bracket 410 side) of the tractor body but extends to the center side in the front-rear direction of the tractor body. With the above configuration, the rear support bracket 410 can have a relatively short dimension, and deflection of the rear support bracket 410 can be reduced or prevented.

Further, in the present example embodiment, the left side camera 40L and the right side camera 40R are attached to the side support bracket 510 via the side camera support 130A. Note that FIG. 12 schematically illustrates the side camera support 130A. As the configuration of the side camera support 130A, for example, various configurations that can be attached to a round bar-shaped attachment target, such as a rear camera support 120 illustrated in FIG. 7, can be adopted.

Further, in the present example embodiment, the recess 11b of the roof 11 is enlarged so as to extend in the front-rear direction, and both the left side camera 40L (right side camera 40R) and the left side radar 50L (right side radar 50R) are located in the recess 11b. With the above configuration, the radar 50 disposed on the side of the roof 11 can be made inconspicuous. Further, with the above configuration, the camera 40 and the radar 50 can be protected from the flying of rain or dust and the contact of branch trees.

Further, in the present example embodiment, the upper surface of the left side radar 50L (right side radar 50R) is disposed below the top portion of the roof 11. With the above configuration, the tractor 1 can be made compact in the vertical direction, and the tractor 1 can be easily stored and transported in a garage or the like.

Note that, in the example described above, the left side camera 40L (right side camera 40R) attached to the side support bracket 510 using the side camera support 130A is positioned in the recess 11b. However, a configuration can be adopted in which the left side camera 40L (right side camera 40R) attached to the center pillar 14 using the side camera support 130 illustrated in FIGS. 4 and 8 is positioned in the recess 11b.

Further, in the above example, the camera 40 and radar 50 are disposed adjacent to each other in the common recess 11b. However, it is not limited to such an arrangement. For example, it is also possible to adopt a configuration in which a plurality of recesses 11b corresponding to each of the camera 40 and the radar 50 is provided, and the camera 40 and the radar 50 are independently disposed in each recess 11b. In addition, a configuration in which only one of the camera 40 and the radar 50 (for example, only the radar 50) is disposed in the recess 11b or a configuration in which both the camera 40 and the radar 50 are not disposed in the recess 11b can also be adopted.

Next, a tractor 1B according to a third example embodiment will be described with reference to FIGS. 13A and 13B. The tractor 1B differs from the tractor according to the first example embodiment in a configuration of a front radar support 210A. The front radar support 210A supports the front radar 50F so as to be located in the cover 340. Note that FIGS. 13A and 13B schematically illustrate the front radar support 210A.

In the present example embodiment, the front radar support 210A is attached to the upper surface of the support plate 330. As a configuration of the front radar support 210A, for example, various configurations that can be attached to a plate-shaped attachment target, such as a front camera support 110 illustrated in FIG. 6, can be adopted.

Further, in the present example embodiment, as illustrated in FIG. 13A, the front surface (the surface that emits radio waves) of the front radar 50F extends along a surface (inclined surface) of side walls of the cover 340 that is inclined to face diagonally forward. Further, in the present example embodiment, as illustrated in FIG. 13B, an opening 341 through which the front radar 50F can be exposed is located in a side wall of the cover 340 defining the inclined surface.

According to the present example embodiment, the front radar 50F can be disposed on a relatively front side. As a result, it is possible to prevent the structures in front of the roof 11 (for example, the muffler 4a, the work lamp, and the like) from being positioned in the detection range of the front radar 50F. Here, the inclined surface of the cover 340 is formed so as not to be positioned within the angle of view of the camera 40 indicated by a two-dot chain line in FIG. 13A. By disposing the front radar 50F along the inclined surface, it is possible to prevent the front radar 50F from being positioned within the angle of view of the camera 40 while disposing the front radar 50F on the front side (in the vicinity of the front camera 40F). Further, with the above configuration, covering the front radar 50F with the cover 340 makes the front radar 50F inconspicuous. Further, with the above configuration, the front radar 50F can be protected from rain, dust flying, and branch tree contact.

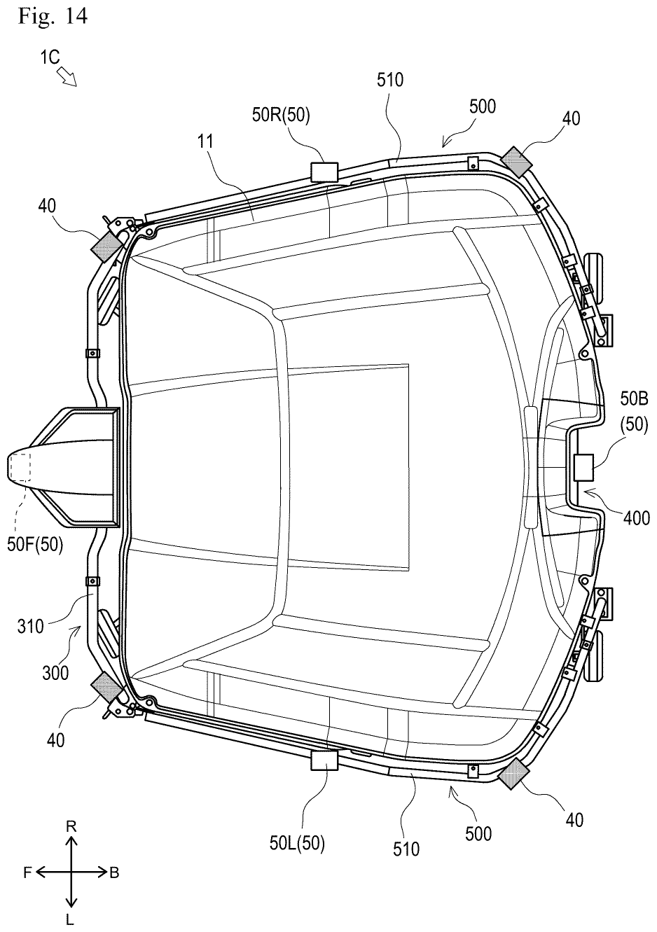

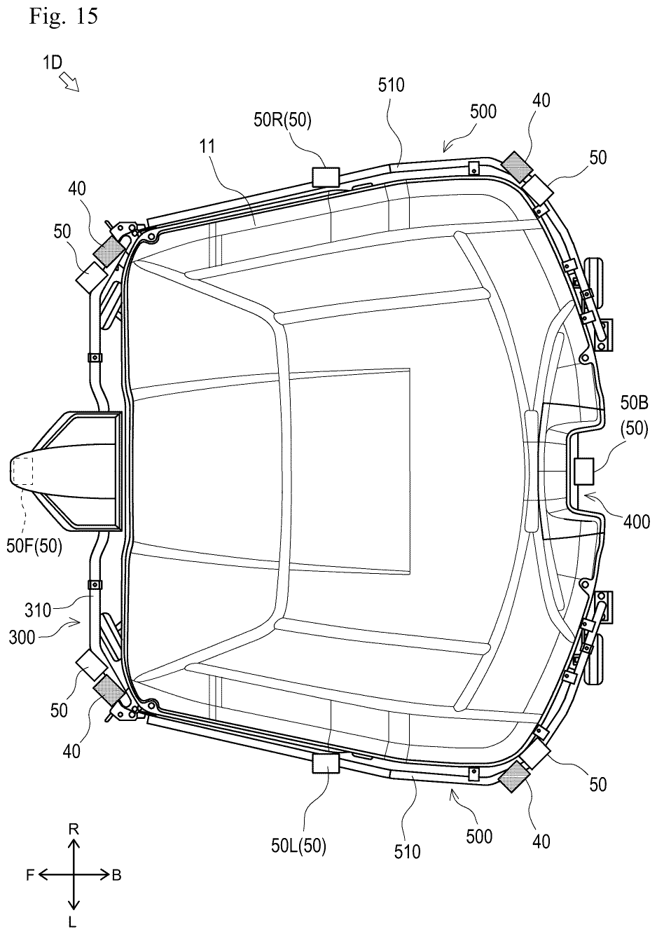

Next, other example embodiments (fourth and fifth example embodiments) in which the arrangement of each camera 40 and each radar 50 is changed will be described with reference to FIGS. 14 and 15. Note that, in FIGS. 14 and 15, the camera 40 and the radar 50 are schematically illustrated, and the camera 40 is painted out. Further, in each drawing, illustration of the camera support 100 and the radar support 200 is omitted. First, a tractor 1C according to a fourth example embodiment will be described with reference to FIG. 14.

In the tractor 1C, one radar 50 is disposed on each of four sides (front, rear, left, and right) in a plan view of the roof 11. Each radar 50 is disposed substantially at the center of the four sides of the roof 11 in plan view. In the present example embodiment, the front radar 50F is located at substantially the center in the left-right direction of the front support (the position where the front camera 40F is disposed in the first example embodiment). Note that the radars 50 other than the front radar 50F are disposed in the same manner as in the first example embodiment.

Further, in the present example embodiment, one camera 40 is located at each of the four corners of the roof 11 in plan view. Each camera 40 is attached to a support (front support 300, rear support 400, and side support 500) surrounding the periphery of the roof 11. Specifically, among the cameras 40, the cameras 40 located at the front corners (the right front corner and the left front corner) are attached to both ends of the front support bracket 310 of the front support 300 in the left-right direction. Further, the cameras 40 located at the rear corners (the right rear corner and the left rear corner) are attached to portions of the side support bracket 510 of the side support 500 located at the right rear corner and the left rear corner of the roof 11. Each of the cameras 40 is attached to each bracket using, for example, the rear camera support 120 illustrated in FIG. 7.

Note that the support serving as the attachment target of each of the cameras 40 at the four corners is not limited to the above-described example. For example, the camera 40 located at the front corner may be attached to the front portion of the side support bracket 510. In addition, the camera 40 located at the rear corner may be attached to both ends of the rear support 400 in the left-right direction.

When the cameras 40 and the radars 50 are disposed as described above, the cameras 40 and the radars 50 are separated from each other, so that the cameras 40 and the radars 50 can be prevented from being located in the imaging range and the detection range of each other. Further, with the above configuration, it is possible to relatively reduce the number of cameras 40 and radars 50 while enabling imaging and detection of substantially the entire circumference (front, rear, left, and right) of the tractor body.

Note that, in the above example, the installation positions of the cameras 40 and the radars 50 can be reversed. That is, the cameras 40 can be disposed on four sides of the roof 11 in plan view, and the radars 50 can be located at four corners of the roof 11 in plan view.

Next, a tractor 1D according to a fifth example embodiment will be described with reference to FIG. 15. In the tractor 1D, in addition to the arrangement of the tractor 1C illustrated in FIG. 14, the radar 50 is located at each of the four corners of the roof 11 in a plan view. That is, in the present example embodiment, the cameras 40 and the radars 50 are located at four corners of the roof 11 in a plan view.

The radars 50 at the four corners are attached to attachment targets (respective brackets of the front support 300 and the side support 500) substantially similar to the cameras 40 at the four corners, for example, by using the front radar support 210 illustrated in FIG. 9, the side radar support 230 illustrated in FIG. 5, and the like. The cameras 40 and the radars 50 at the four corners are disposed adjacent to each other. The radar 50 can be disposed on the center side of the tractor 1 with respect to the cameras 40 so as not to be positioned within the angle of view of the adjacent cameras 40. With the configuration of the present example embodiment, by increasing the number of radars 50, blind spots in the detection range of radars 50 can be reduced.

As described above, the tractors 1 to 1D (working vehicle) according to the present example embodiment include the cabin 10 including the roof 11, and at least one radar 50 (detector) located at the height of the roof 11 to detect a detection target around the tractor body.

With such a configuration, it is possible to suitably detect a detection target. That is, unlike a case where the radar 50 is located at a relatively low position (for example, the height of the hood 4), detection of an unintended object such as vegetation can be reduced or prevented.

Further, the radar 50 includes a front radar 50F (front detector) to detect the front of the tractor body.

With such a configuration, it is possible to suitably detect a detection target in front of the tractor body.

Further, the radar 50 includes a rear radar 50B (rear detector) to detect the rear of the tractor body.

With such a configuration, it is possible to suitably detect a detection target behind the tractor body.

Further, the radar 50 includes a side detector (left side radar 50L or right side radar 50R) to detect at least one of a left side or a right side of the tractor body.

With such a configuration, it is possible to suitably detect a detection target on the left side or the right side of the tractor body.

Further, a plurality of the radars 50 is provided.

With such a configuration, it is possible to suitably perform detection in a plurality of directions.

In addition, the tractors 1 to 1D include a plurality of cameras 40 (imagers) located at the height of the roof 11 and capable of imaging the surroundings of the tractor body.

With such a configuration, it is possible to suitably perform imaging using the camera 40. That is, unlike a case where the camera 40 is located at a relatively low position, it is possible to suppress imaging of an unintended target.

In addition, the tractors 1 to 1D include a support (front support 300, rear support 400, and side support 500) that is disposed on the outer periphery of the roof 11 to support the radar 50 and the camera 40.

With such a configuration, the plurality of radars 50 and the plurality of cameras 40 can be disposed on the outer periphery of the roof 11 using the support (front support 300, rear support 400, and side support 500).

Further, the roof 11 has a top portion, and the radar 50 is disposed such that an upper surface of radar 50 is positioned below the top portion.

With such a configuration, the tractor 1 can be made compact in the vertical direction, and the tractor 1 can be easily stored and transported in a garage or the like.

Further, the detector is a radar 50 to detect the detection target by emitting a radio wave, the support includes the front support 300 located in front of the roof 11, and the front support 300 supports the radar 50 and the camera 40.

With such a configuration, it is possible to suitably perform detection and imaging using radio waves in front of the tractor body.

Further, the tractors 1 to 1D include a position detector 30 to detect the position of the tractor body and supported by the front support 300, in which the radar 50 is located such that an upper surface of the radar is positioned below the position detector 30.

With such a configuration, the tractor 1 can be made compact in the vertical direction, and the tractor 1 can be easily stored and transported in a garage or the like.

Further, the support includes the side support 500 disposed on a side of the roof 11 and the fixture 520 (connecting portion) that connects the front support 300 and the side support 500 to each other.

With such a configuration, structures capable of supporting the radar 50 and the camera 40 to the front and the side of the tractor body can be suitably connected to each other.

Further, an outer peripheral portion (side) of the roof 11 includes the recess 11b that is recessed toward a center side of the roof 11 in a plan view, and the plurality of radars 50 and the plurality of cameras 40 include the radars 50 (left side radar 50L, right side radar 50R) and the cameras 40 (left side camera 40L, right side camera 40R) located adjacent to each other so as to be positioned inside the recess 11b.

With such a configuration, the radar 50 and the camera 40 located on the outer peripheral portion of the roof 11 can be made inconspicuous.

In addition, the support (front support 300) includes a cover 340 (cover portion) that covers the radar 50 (front radar 50F) and the camera 40 (front camera 40F) from above, the cover 340 includes a side wall that is not positioned within an angle of view of the front camera 40F, and the front radar 50F covered by the cover 340 extends along the side wall.

With such a configuration, it is possible to prevent the front radar 50F from being positioned within the angle of view of the camera 40 while locating the front radar 50F in the vicinity (front side) of the front camera 40F.

Further, one of the plurality of radars 50 and the plurality of cameras 40 is located at least on each of four sides in a plan view of the roof 11 so as to enable detection or imaging in forward, rearward, and both left and right directions from the tractor body, and another of the plurality of radars 50 and the plurality of cameras 40 is located at least at each of four corners in a plan view of the roof 11 so as to enable detection or imaging in forward, rearward, and both left and right directions from the tractor body.

With such a configuration, the plurality of radars 50 and the plurality of cameras 40 can be located at positions where the radars and the cameras can be prevented from being located in the imaging range and the detection range.

Further, one of the plurality of radars 50 and the plurality of cameras 40 is located on both four sides and four corners of the roof 11 in a plan view.

With such a configuration, blind spots in the detection range of radar 50 or the imaging range of camera 40 can be reduced.

Note that the tractor 1 according to the present example embodiment is an example embodiment of the working vehicle according to the present invention.

Further, the camera 40 according to the present example embodiment is an example embodiment of an imager according to the present invention.

Further, the front radar 50F according to the present example embodiment is an example embodiment of the front detector according to the present invention.

Further, the rear radar 50B according to the present example embodiment is an example embodiment of the rear detector according to the present invention.

Further, the left side radar 50L and the right side radar 50R according to the present example embodiment are example embodiments of the side detector according to the present invention.

Further, the radar 50 according to the present example embodiment is an example embodiment of the detector according to the present invention.

Further, the front support 300, the rear support 400, and the side support 500 according to the present example embodiment are example embodiments of the support according to the present invention.

Further, the cover 340 according to the present example embodiment is an example embodiment of the cover portion according to the present invention.

Further, the fixture 520 according to the present example embodiment is an example embodiment of the coupling portion according to the present invention.

Although the example embodiments of the present invention have been described above, the present invention is not limited to the above configuration, and various modifications can be made within the scope of the invention described in the claims.

Specifically, the arrangement of the camera 40 and the radar 50 is not limited to the example described in each of the above example embodiments (first to fifth example embodiments). For example, in the fifth example embodiment illustrated in FIG. 15, any one of the radars 50 disposed on four sides (front, rear, left, and right) in a plan view of the roof 11 may be reduced.

Further, in each of the above example embodiments, the plurality of cameras 40 and the plurality of radars 50 are provided so that the entire circumference (front, rear, left, and right) of the tractor body can be imaged and detected. However, it is not limited to this example. For example, at least one camera 40 and radar 50 may be provided so as to be able to capture and detect any one of the front, rear, left, and right of the tractor body.

Further, the arrangement and number of the cameras 40 and the radars 50 are not limited to the specific positions and numbers described in the above example embodiments. As for the arrangement and number of the cameras 40 and the radars 50, the positions of the cameras 40 and the radars 50 described in each example embodiment can be appropriately changed or the number can be appropriately set (increased or decreased) according to the content of the automatic control of the tractor 1, in addition to the above-described example.

Further, the orientations (angles in the horizontal direction and the vertical direction) of the camera 40 and the radar 50 are not limited to the examples described in the above example embodiments. For example, in the third example embodiment illustrated in FIGS. 13A and 13B, the front surface of the front radar 50F is disposed obliquely forward along the inclined surface of the cover 340. However, a configuration in which the front surface of the front radar 50F is disposed to face the front (forward) can also be adopted. In addition, various orientations can be set as the orientation of each camera 40 and each radar 50 from the viewpoint of suitably imaging and detecting the periphery of the tractor body.

Further, the height position of each radar 50 is not limited to the example described in each of the above example embodiments. For example, at least one of the plurality of radars 50 may be located at the height position of the roof 11, and the other radars 50 may be disposed outside the height position of the roof 11 and below the roof 11 (the upper surface of each radar 50 is positioned below the lowest portion of the roof 11). In addition, the other radar 50 may be disposed outside the range of the height position of the roof 11 and above the roof 11 (the lower surface of each radar 50 is positioned above the top portion of the roof 11).

Further, the height position of each camera 40 is not limited to the example described in each of the above example embodiments. For example, at least one of the cameras 40 may be disposed so as to be located outside the range of the height position of the roof 11 and below the roof 11 (the upper surface of the camera 40 is positioned below the lowest portion of the roof 11) or above the roof 11 (the lower surface of the camera 40 is positioned above the top portion of the roof 11).

Further, in each of the above example embodiments, an example has been described in which the cabin 10 includes the front pillar 12, the rear pillar 13, and the center pillar 14 (six-pillar type). However, the present invention is not limited to this. As the cabin 10, for example, various configurations such as a configuration not including the center pillar 14 (four-pillar type) can be adopted.

Further, the configurations of the camera support 100 and the radar support 200 described in the above example embodiments are merely examples, and the structures to mount the cameras 40 and the radars 50 around the roof 11 are not limited to the above examples, and various structures can be adopted.

Further, the configuration of the support (front support 300, rear support 400, and side support 500) described in each of the above example embodiments is an example, and the attachment target of the camera support 100 and the radar support 200 is not limited to the above example, and various structures and arrangements can be adopted.

Further, in each of the above example embodiments, the radar 50 that performs detection using radio waves is preferably used as the detector. However, it is not limited to such an arrangement. As the detector, for example, various devices to detect a detection target around the tractor body, such as an ultrasonic sensor, can be adopted.

In addition, the shape, structure, and the like of each unit exemplified in the above example embodiments are merely examples, and the configuration of each unit can be arbitrarily changed.

Further, in the above example embodiments, the tractor 1 has been exemplified as the working vehicle. However, it is not limited to such this example. For example, the working vehicle may be another agricultural vehicle, a construction vehicle, an industrial vehicle, or the like.

Example embodiments of the present invention can be applied to working vehicles.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A working vehicle comprising:
a cabin including a roof; and
at least one detector located at a height of the roof to detect a detection target around a tractor body.

2. The working vehicle according to claim 1, wherein the at least one detector includes a front detector to detect a front of the tractor body.

3. The working vehicle according to claim 1, wherein the at least one detector includes a rear detector to detect a rear of the tractor body.

4. The working vehicle according to claim 1, wherein the detector includes a side detector to detect at least one of a left side or a right side of the tractor body.

5. The working vehicle according to claim 1, wherein
a plurality of the detectors is provided.

6. The working vehicle according to claim 5, further comprising:
a plurality of imagers located at a height of the roof to image surroundings of the tractor body.

7. The working vehicle according to claim 6, further comprising:
a support located on an outer periphery of the roof to support the at least one detector and the imager.

8. The working vehicle according to claim 1, wherein
the roof includes a top portion; and
the detector is located such that an upper surface of the at least one detector is below the top portion.

9. The working vehicle according to claim 7, wherein
the at least one detector is a radar to detect the detection target by emitting a radio wave;
the support includes a front support located in front of the roof to support the radar and the imager.

10. The working vehicle according to claim 9, further comprising:
a position detector to detect a position of the tractor body and supported by the front support; wherein
the radar is located such that an upper surface of the radar is below the position detector.

11. The working vehicle according to claim 9, wherein the support includes a side support located on a side of the roof and a connecting portion that connects the front support and the side support to each other.

12. The working vehicle according to claim 6, wherein
an outer peripheral portion of the roof includes a recess that is recessed toward a center side of the roof in a plan view; and
the plurality of detectors and the plurality of imagers include the detector and the imager located adjacent to each other so as to be located inside the recess.

13. The working vehicle according to claim 7, wherein
the support includes a cover portion that covers the detector and the imager from above;
the cover portion includes a side wall that is not within an angle of view of the imager; and
the detector covered by the cover portion extends along the side wall.

14. The working vehicle according to claim 6, wherein
one of a plurality of the detectors and a plurality of the imagers is located at least on each of four sides in a plan view of the roof so as to enable detection or imaging in forward, rearward, and both left and right directions from the tractor body; and
another of the plurality of the detectors and the plurality of the imagers is located at least on each of four corners in a plan view of the roof so as to enable detection or imaging in forward, rearward, and both left and right directions from the tractor body.

15. The working vehicle according to claim 14, wherein one of the plurality of detectors and the plurality of imagers is located on both four sides and four corners of the roof in a plan view.

16. The working vehicle according to claim 2, wherein
a plurality of the detectors is provided.

17. The working vehicle according to claim 3, wherein
a plurality of the detectors is provided.

18. The working vehicle according to claim 4, wherein
a plurality of the detectors is provided.

19. The working vehicle according to claim 16, further comprising:
a plurality of imagers located at a height of the roof to image surroundings of the tractor body.

20. The working vehicle according to claim 17, further comprising:
a plurality of imagers located at a height of the roof to image surroundings of the tractor body.
